(19) United States
(12) Patent Application Publication
(10) Pub. No.: US 2004/0053006 A1
(43) Pub. Date: Mar. 18, 2004

(54) Intermediate film for laminated glass

(75) Inventors: Morimasa Omizu, Minakuchicho (JP); Tokushige Shichiri, Shimamotocho (JP)

Correspondence Address: CONNOLLY BOVE LODGE & HUTZ LLP, SUITE 800, 1990 M STREET NW, WASHINGTON, DC, 20036-3425, US

(73) Assignee: Sekisui Chemical Co., Ltd., Osaka (JP)

(21) Appl. No.: 10/653,296

(22) Filed: Sep. 3, 2003

Related U.S. Application Data
(63) Continuation of application No. 09/623,973, filed on Oct. 27, 2000.
Application No. 09/623,973 is a 371 of international application No. PCT/JP99/01177, filed on Mar. 11, 1999.

(30) Foreign Application Priority Data
Mar. 11, 1998 (JP) 10/59929
Jul. 13, 1998 (JP) 10/197558

(51) Int. Cl. B32B 3/00

(52) U.S. Cl. 428/156

(57) ABSTRACT

The present invention has for its object to provide an intermediate film for laminated glass which does not give rise to the trouble of poor appearance in its lamination with glass and can be easily produced without remodeling of the existing production equipment and superior in productivity.

The present invention is related to intermediate film for laminated glass which is used in the manufacture of laminated glass by sandwiching it between two facing glass sheets, which comprises a section profile diminishing in thickness in the manner of a curve in the axial direction thereof.

### TECHNICAL FIELD

The present invention relates to an intermediate film for laminated glass suited for a head-up display in its application to an automotive windshield, a process for its production, a laminated glass incorporating said intermediate film for laminated glass, a roll of intermediate film for laminated glass, and a method for its manufacture.

### PRIOR ART

In the front of a motor car, an airplane or the like, the so-called windshield known also as front glass is used. The front glass is usually a glass laminate consisting of two faced glass sheets and an intermediate film for laminated glass as sandwiched between the glass sheets.

Recent years have mounted a need, from safety considerations, for windshield of an automobile, the instrument-generated information such as speed and other running data of an automobile, for instance, can be displayed on the so-called head-up display (HUD) within the same visual field of the driver as the windshield.

Regarding the mechanism of HUD, many systems have heretofore been developed. In a typical system, the HUD display area does not exist on the surface of the windshield glass but the driver perceives the reflection of the data as a virtual image in the same position (that is to say, within the same visual field) as the windshield. However, since the laminated glass of windshield consists of two parallel sheets of glass, this system has the disadvantage that the driver has a double vision of the instrument display.

To overcome this disadvantage, U.S. Pat. No. 5,013,134 discloses a technology of disposing an intermediate film having a wedge angle within the windshield glass. U.S. Pat. No. 5,087,502 discloses a wedge-shaped sheet and a method for its manufacture. Furthermore, U.S. Pat. No. 5,639,538 discloses a sheet which is uniform in thickness over at least 20% of its total area extending from either edge thereof and diminishes gradually in thickness toward the mid-line and which is to be slit around the mid-line.

Because those intermediate films for laminated glass are wedge-shaped in section, the above technologies have the disadvantage that trimming film are often produced in the lamination with grass and hence the efficiency is sacrificed. Moreover, since the sheet is partially uniform in thickness and wedge-shaped in the remainder, the risk is high for the deterioration of poor appearance along the borderline between the part uniform in thickness and the part having a wedge-shaped thickness profile in the lamination process.

When such an intermediate film having a wedged-shaped profile is applied to the curved wrap-around front glass, it is common practice to stretch the intermediate film in compliance with the surface configuration of the glass, thus making the film uniform in thickness.

As described typically in Japanese Kokai Publication Hei-3-209210, it is known that by using an intermediate film having a wedge-shaped thickness profile with its shape retained for the front glass having a head-up display function, a sharp reflection image can be formed without causing a double vision.

Meanwhile, any intermediate film having a wedge-shaped thickness profile is wound up in the manner of roll to form a cone due to ununiform thickness and it is necessary to vary the angle of the core according to the length of film to be wound. Furthermore, because the resulting roll is conical, there is naturally a limit to the length of film that can be wound per roll so that the transportation efficiency of rolls is decreased and the instability of the roll makes handling difficult. When a conical core is used for winding, the roll is cylindrical and stable but the length of film that can be wound per roll is further decreased to sacrifice the efficiency of transportation.

As an intermediate film which overcomes the above disadvantages, Japanese Kohyo Publication Hei-7-508690 describes an intermediate film which is uniform in thickness over a given distance from both edges of the film and diminishing in thickness symmetrically from the first-mentioned parts toward the center of the film, thereby allowing the film to be taken up in the form of a cylindrical roll with a constant radius.

However, the intermediate film described in Japanese Kohyo Publication Hei-7-508690 is so complicated in sectional configuration that it is not easy to manufacture and, in addition, has the disadvantage that wrinkles are liable to occur in the central part of relatively thin thickness.

### SUMMARY OF THE INVENTION

The present invention, developed in view of the above state of the art, has for its object to provide an intermediate film for laminated glass which does not give rise to the trouble of poor appearance in its lamination with glass and can be easily produced without remodeling of the existing production equipment and superior in productivity.

A further object of the present invention is to provide a roll of intermediate film for laminated glass which overcomes the disadvantages of the conventional roll of intermediate film for laminated glass and, as such, is easy to handle and contributory to transportation efficiency and a process for its production.

The present invention is directed to an intermediate film for laminated glass used in the manufacture of laminated glass by sandwiching it between two facing glass sheets,

which comprises a sectional profile diminishing its thickness transversely in the manner of a curved form.

The present invention is further directed to an intermediate film for laminated glass used in the manufacture of laminated glass by sandwiching it between two facing glass sheets,

which comprises a sectional profile comprising a continuum of arcs having two or more different radii.

The present invention is further directed to a method of producing the intermediate film for laminated glass

which comprises feeding a starting composition for the intermediate film for laminated glass to a production equipment having an extruder, an extrusion die, a first cooling pressure roll and a second cooling pressure roll,

both of the cooling pressure roll having the clearances respectively controlled according to the sectional profile of the intermediate film to be produced.

The present invention is further directed to a laminated glass comprising the intermediate film for laminated glass of the present invention. There is no particular limitation on the kind of glass that can be used for the laminated glass of the present invention. For example, it may be an inorganic glass such as float glass or an organic glass such as polycarbonate glass.

The roll of intermediate film for laminated glass of the present invention increases in thickness of the film from one edge to the other edge in the axial direction,

which comprises windings of two continuous strips of an intermediate film as wound in superimposition one on the other with its edge of one strip thinner in thickness being aligned with its edge of the other strip greater in thickness.

The method of producing a roll of intermediate film for laminated glass increases in thickness of the film from one edge to the other edge in the axial direction,

which comprises winding two continuous strips of an intermediate film as rolled up in superimposition one on the other with its edge of one strip thinner in thickness being aligned with its edge of the other strip greater in thickness.

### BRIEF DESCRIPTION OF THE DRAWINGS

FIG. 1 is a layout of production equipment for producing the intermediate film for laminated glass of the present invention.

FIG. 2 is a schematic cross-section view showing the first cooling pressure roll in the above equipment for the production of the intermediate film for laminated glass in accordance with this invention.

FIG. 3 is a schematic cross-section view showing the second cooling pressure roll in the equipment for the production of the intermediate film for laminated glass of the present invention.

FIGS. 4-1 is a sectional view showing the intermediate film for laminated glass produced by the process of producing the intermediate film for laminate glass of the present invention.

FIGS. 4-2 is a sectional view showing the intermediate film for laminated glass produced by the process of producing the intermediate film for laminate glass of the present invention.

FIG. 5 is a sectional view showing an intermediate film having the wedge-shaped thickness profile as obtainable by the method of Comparative Example 1.

FIG. 6 is a sectional view showing an intermediate film having the wedge-shaped profile as obtainable by the method of Comparative Example 2.

FIG. 7 is an elementary section view showing an example of the roll of intermediate film for laminated glass in accordance with this invention.

FIG. 8 is an elementary section view of an intermediate film having a wedge-shaped thickness profile.

FIG. 9 is a perspective view showing the extrusion die for use in the production of an intermediate film having a wedge-shaped thickness profile.

FIG. 10 is a sectional view showing the conventional roll.

Each reference numeral represents:

1. extruder

2. extrusion die for molding

3. first cooling pressure roll

4. second cooling pressure roll

5. ancillary equipment

11. core

12. intermediate film

13. extrusion die

131. orifice of resin

### DEATAILED DESCRIPTION OF THE INVENTION

Hereinafter, the invention is described in detail.

Provided that it is a transparent thermoplastic resin, there is no particular limitation on the material for the intermediate film for laminated glass of the present invention. For example, such conventional materials as polyvinyl butyral resin, polyurethane resin and ethylene-vinyl acetate copolymer resin can be employed.

The intermediate film for the laminated glass of the present invention is characterized by its unique sectional profile, and such an intermediate film for laminated glass is sandwiched between the two glass sheets. Thus, said sectional profile is such that the thickness of the sheet diminishes in the manner of a curve in the axial direction thereof. Moreover said profile comprises a continuum of arcs having two or more different radii.

The term “diminishing in the manner of a curve” means that the intermediate film for laminated glass is gradually decreased in thickness along a curvature in the axial direction thereof.

The arc means a part of the circumference of a circle. The “two or more arcs” means that said continuum consists of a plurality of arcs and excludes the case in which the continuum consists in a single arc. Said arcs differ in the radius. That the arcs differ in the radius means that the radius of arc of one arc is different from the radius of another arc. Although arcs of the same radius of arc may exist among said plurality of arcs, the case in which all the arcs are equal in the radius of arc is excluded. The ratio of the number of arcs differing in the radius to the total number of arcs is preferably as many as possible.

The continuum of such arcs means a continual array of arcs. In other words, because of existing the arcs continually, such arcs exist in partially overlapped relation between adjacent circles.

Unlike the conventional intermediate film for laminated glass, the intermediate film for laminated glass having the above profile is free from the disadvantage of often giving rise to trimming film in the lamination process with glass. Moreover, compared with the prior art film which is partially uniform in thickness and wedge-shaped in the remaining part, the intermediate film for laminated film of the present invention does not cause the trouble of poor appearance along the borderline between the part of uniform thickness and the part having a wedge-shaped thickness profile in the lamination process with glass.

The process for producing the intermediate film for laminated glass of the present invention is now described in detail, reference being had to the accompanying drawings.

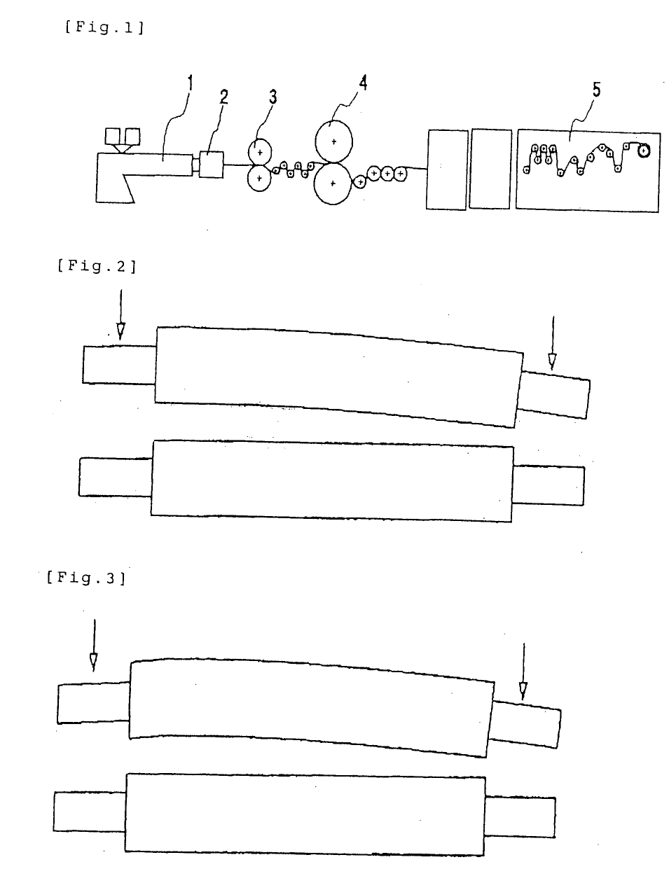

FIG. 1 is a schematic view showing a typical production equipment for use in the process for producing the intermediate film for laminated glass of the present invention. This production equipment comprises an extruder 1, an extrusion die 2, a first cooling pressure roll 3, a second cooling pressure roll 4 and ancillary equipment 5.

The thermoplastic resin for use as the material for the intermediate film for laminated glass of the present invention is provided in the extruder 1 and delivered in molten state to the extrusion die 2. The thermoplastic resin extruded in sheet form from this extrusion die is passed through said first cooling pressure roll 3 and further through said second cooling pressure roll 4, and finally wound up on a take-up device.

FIG. 2 shows the mechanism of action of the first cooling pressure roll 3. This first cooling pressure roll 3 is set to provide a clearance varying gradually from one axial end to the other, and dissimilar pressures are applied to the axial ends of the roll. Because of the deflection of the pressure rolls in response to the pressures applied, the thickness of the thermoplastic resin film can be varied transversally in a continuum of arcs having two or more radii.

FIG. 3 shows the mechanism of action of the second cooling pressure roll 4. This second cooling pressure roll 4 has a clearance with a gradient substantially corresponding to the transverse thickness of the thermoplastic resin film molding from said first cooling pressure roll 3 and has a uniformly patterned surface. As both axial ends of the second cooling pressure roll 4 are subjected to pressures not below predetermined levels, an intermediate film for laminated glass having a uniformly patterned surface can be produced.

Thus, the thermoplastic resin extruded from the extrusion die is guided to the first cooling pressure roll which has been set to have a different clearance between the two axial ends of the roll beforehand. Different pressures are applied to said axial ends of said cooling pressure roll respectively, whereupon the resulting deflection of the roll causes the resin film to assume a wedge-shape thickness profile in the axial direction. The film is further applied to said second cooling pressure roll which has been set to a different clearance between its two axial ends and dissimilar pressures are applied to the axial ends of the roll, whereby the film is provided with a section profile diminishing in thickness in the manner of a curve and, at the same time, evenly embossed in the axial direction thereof.

By the above-mentioned process, the intermediate film for laminated glass of the present invention can be obtained.

As mentioned above, the intermediate film for laminated glass of the present invention contributes greatly to the HUD function of the windshield, and the laminated glass obtainable by using such an intermediate film for laminated glass also falls within the scope of the present invention.

The roll of intermediate film for laminated glass of the present invention is now described in detail.

The material for the intermediate film for laminated glass of the present invention is not particularly restricted but includes those materials which are conventionally used for the purpose. Thus polyvinyl butyral resin, ethylene-vinyl acetate copolymer, and polyvinyl chloride resin can be mentioned for example.

In this aspect of the present invention, the mode of increase in the thickness of intermediate film from one edge to the other in the axial direction may be a linearly incremental one, i.e. the so-called wedge profile, or may be an increase in thickness in the manner of a curve.

The rate of change in thickness of the intermediate film is preferably about 0.1 to 0.7 mm per meter of its width. For HUD use, the preferred rate of change in thickness of the intermediate film for laminated glass is about 0.2 to 0.3 mm per meter of its width.

Furthermore, the two strips of intermediate film for laminated glass may be equal, or more or less different in the rate of change in thickness.

The preferred thickness of the intermediate film for laminated glass is about 0.3 mm in the position of minimum thickness and about 1 mm in the position of maximum thickness. If the thickness of the intermediate film for laminated glass is less than 0.3 mm, the penetration resistance of the laminated glass will be insufficient and, in addition, a slack will be created in the film under its own weight during production. Conversely if 1 mm is exceeded, the penetration resistance will be excessive and a disadvantage will be inevitable in the cost-wise.

Continuous strips of intermediate film for laminated glass each increasing in thickness from one edge to the other in the axial direction can be produced by adjusting the orifice of resin of each extrusion die for molding in accordance with the thickness of the desired film or by passing the extruded strips between a pair of rolls to control the shape and/or clearance of the desired film.

Where necessary, the intermediate film for laminated glass may be provided with a color band, either locally or throughout its area, and such a color band can be provided by coextrusion of a colored resin or by printing the necessary pattern on the surface of the intermediate film.

In the method of producing a roll of intermediate film for laminated glass of the present invention, two strips of intermediate film for laminated glass may be extruded either from a single extruder or from two extruders. When two extruders are used, the two strips of intermediate film for laminated glass need not be concurrently extruded but the two strips may be respectively taken up in rolls and, then, superimposed one upon the other. As an alternative, one strip of intermediate film for laminated glass is extruded and taken up in a conical fashion and the other strip is then extruded and wound onto the windings of the first strip. As a further alternative, the second strip of intermediate film for laminated glass may be extruded and wound in the superimposition the first strip wound in advance while the latter is continuously rewound from its roll to thereby provide a cylindrical roll.

The roll of intermediate film for laminated glass of the present invention comprises windings of two strips of intermediate film for laminated glass each increasing in thickness in the axial direction thereof from one edge to the other as wound in superimposition one on the other with its edge of one strip greater in thickness being aligned with its edge of the other strip thinner in thickness. Therefore, the resulting roll has a substantially cylindrical profile which is easy to transport and handle.

In the method of producing a roll of intermediate film for laminated glass of the present invention, two continuous strips of an intermediate film for laminated glass are rolled up in superimposition one on the other with its edge of one strip greater in thickness being aligned with its edge of the other strip thinner in thickness, with the result that the resulting roll is a cylindrical roll with a substantially constant radius and, as such, can be easily handled and transport.

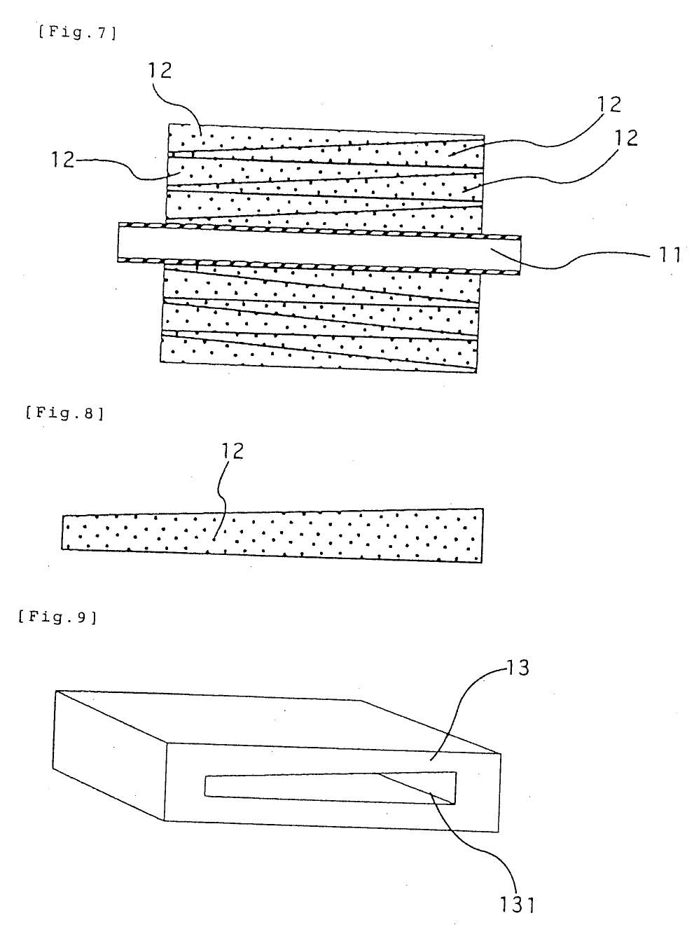

FIG. 7 is a schematic cross-section view showing an exemplary roll of an intermediate film for laminated glass of the present invention.

Referring to FIG. 7, the reference numeral 11 represents a core on which said intermediate film for laminated glass is wound to provide the roll of the present invention. The reference numeral 12 represents an intermediate film which, as best shown in FIG. 8, has a thickness profile increasing in thickness in the axial direction thereof from one edge to the other.

As shown, two continuous strips 12, 12 of intermediate film each having such a wedge-shaped thickness profile are superimposed one on the other with its edge of one strip 12 thinner in thickness being aligned with its edge of the other strip 12 greater in thickness.

The intermediate film 12 having said wedge-shaped profile can be produced, for example by using an extrusion die 13 having an orifice of resin 131 with its edge of one greater than the other edge in thickness as shown in FIG. 9.

In the roll of intermediate film for laminated glass of the present invention shown in FIG. 7, two continuous strips 12, 12 of intermediate film each having such a wedge-shaped thickness profile are superimposed one on the other with its edge of one strip 12 thinner in thickness being aligned with its edge of the other strip 12 greater in thickness. Therefore, the resulting roll has a substantially cylindrical profile which is easy to transport and handle.

The preferred embodiments of this invention have been described above with reference to the drawings but many changes and modifications can be made by those skilled in the art without departing from the appended claims.

For example, the core 11 need not always be employed in winding the intermediate film for laminated glass.

### BEST MODE FOR CARRYING OUT THE INVENTION

The following examples illustrate the present invention in further detail, and those examples are by no means defining the scope of the present invention.

### EXAMPLE 1

Using the production equipment shown in FIG. 1, an intermediate film for laminated glass was produced under the following conditions.

Extrusion Die

Slit width: 1300 mm

Die temperature: 180° C.

First Cooling Pressure Roll

Effective roll length: 2000 mm

temperature: 40° C.

Second Cooling Pressure Roll

Effective roll length: 2000 mm

Roll clearance: 0.47 mm

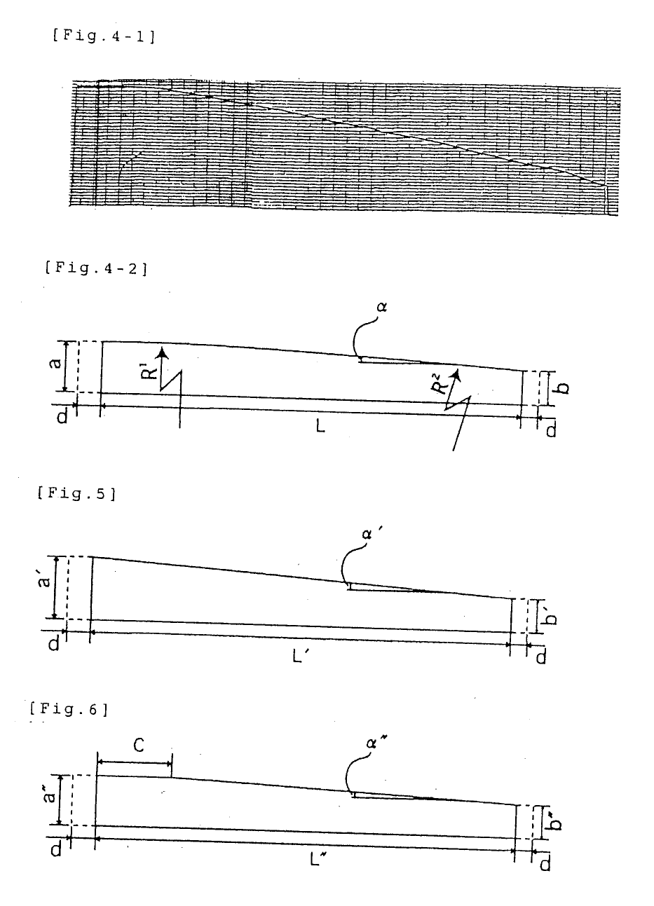

The sectional configuration of the intermediate film for laminated glass produced is shown in FIGS. 4-1 and 4-2. The thickness profile and arc radii of this intermediate film for laminated glass are shown in Table 1.

The intermediate film according to Example 1 had a thickness profile comprising a continuum of arcs having two or more different radii.

TABLE 1

| | | |
|---|---|---|
| width (L) | 1070 | mm |
| thickness (a) | 1.35 | mm |
| thickness (b) | 0.8 | mm |
| length of | 30 | mm |
| trimming (d) | | |
| major radius (R₁) | 250 | m |
| major radius (R₂) | 330 | m |

### COMPARATIVE EXAMPLE 1

Using the same production equipment as used in Example 1, an intermediate film having the wedge-shaped thickness profile illustrated in FIG. 5 was produced. Here, the respective clearances of the first cooling pressure roll and second cooling pressure roll were adjusted so that the gradient (α′) of the thickness profile in the axial direction would be approximately equal to the gradient (α) according to Example 1. The thickness profile is shown in Table 2.

The intermediate films for laminated glass of Example 1 and Comparative Example 1 were compared with (α) of each other in regard to the weight of trimmings per 100 meters. The respective weight data are given in Table 3.

TABLE 2

| | | |
|---|---|---|
| width (L) | 1070 | mm |
| thickness (a′) | 1.50 | mm |
| thickness (b′) | 0.8 | mm |
| length of | 30 | mm |
| trimming (d) | | |

TABLE 3

| | |
|---|---|
| Ex. 1 | 7.5 kg |
| Comp. Ex. 1 | 6.9 kg |

### COMPARATIVE EXAMPLE 2

Using the same production equipment as used in Example 1, an intermediate film having the wedge-shaped profile illustrated in FIG. 6 was produced.

Here, the respective clearances of the first and second cooling pressure rolls were adjusted so that the gradient (α″) of the thickness profile in the axial direction would be substantially equal to the gradient (α) according to Example 1. The thickness profile is shown in Table 4.

The intermediate film for laminated glass of Example 1 and the intermediate film for laminated glass of Comparative Example 2 were respectively used in combination with flat glass sheets 3.00 mm each to fabricate a laminated glass. The laminated glass fabricated using the intermediate film for laminated glass of Comparative Example 2 was found to have been strained.

TABLE 4

| | | |
|---|---|---|
| width (L) | 1070 | mm |
| thickness (a″) | 1.35 | mm |
| thickness (b″) | 0.8 | mm |
| thickness (c) | 230 | mm |
| length of | 30 | mm |
| trimming (d) | | |

### EXAMPLE 2

Using a plasticized polyvinyl butyral resin and a biaxial extruder and the die shown in FIG. 9, a first strip of intermediate film having a wedge-shaped profile was produced. As shown in FIG. 8, this intermediate film for laminated glass had a thickness of 0.76 mm at one edge and a thickness of 0.98 mm at the other edge. Concurrently, using another biaxial extruder and the same die as illustrated in FIG. 9, a second strip of intermediate film having the same wedge-shaped thickness profile as the first strip was extruded. As shown in FIG. 7, the above two strips of intermediate film were superimposed one on the other with its edge of one strip thinner in thickness being aligned with its edge of the other strip greater in thickness and concurrently wound up on a cylindrical core, 200 mm in outer diameter, for a total of 150 turns to provide a cylindrical roll with a constant diameter of 730 mm.

### COMPARATIVE EXAMPLE 3

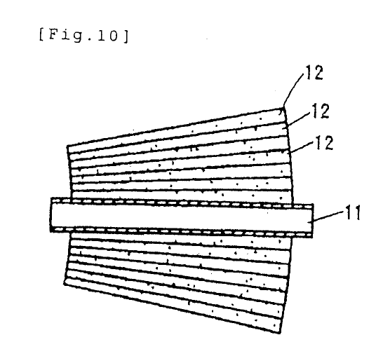

The procedure of Example 2 was repeated to produce two strips of intermediate film having the same wedge-shaped thickness profile. As shown in FIG. 10, the two strips were wound up in superimposition on a cylindrical core, 200 mm in outer diameter, with its edge of one strip thinner in thickness being aligned with its edge of the other strip thinner in thickness for a total of 300 turns. The resulting roll was a conical roll which was 660 mm in diameter at one end and 790 mm in diameter at the other end.

### INDUSTRIAL APPLICABILITY

In accordance with this invention described above, there can be obtained an intermediate film for laminated glass with a greater rate of diminution in thickness in the axial direction as compared with the conventional intermediate film having a wedge-shaped thickness profile with assurance of improved contact with glass, without the incidence of poor appearance-and without requiring remodeling of the existing equipment. This intermediate film for laminated glass is very suitable for head-up display purposes.

The roll of intermediate film for laminated glass of the present invention consists of two strips of an intermediate film for laminated glass having a wedge-shaped thickness profile in the axial direction as wound up in superimposition one on the other with its edge of one strip thinner in thickness being aligned with its edge of the other strip greater in thickness, with the result that the resulting roll is a cylindrical roll with a substantially constant radius which is easy to handle and transport.

In the method of producing a roll of intermediate film for laminated glass of the present invention, two strips of an intermediate film for laminated glass are rolled up in superimposition one on the other with its edge of one strip greater in thickness being aligned with its edge of the other strip thinner in thickness, with the result that the resulting roll is a cylindrical roll with a substantially constant radius and, as such, can be easily handled and transport.

1. An intermediate film for laminated glass used in the manufacture of laminated glass by sandwiching it between two facing glass sheets,
which comprises a section profile diminishing in thickness in the manner of a curve in the axial direction thereof.

2. An intermediate film for laminated glass used in the manufacture of laminated glass by sandwiching it between two facing glass sheets,
which comprises a section profile comprising a continuum of arcs having two or more different radii.

3. A method of producing the intermediate film for laminated glass according to claim 1 or 2 used in the manufacture of laminated glass,
which comprises feeding a starting composition for the intermediate film to a production equipment having an extruder, an extrusion die, first cooling pressure roll, and second cooling pressure roll,
both of the cooling pressure rolls having the clearances controlled according to the sectional profile of the intermediate film to be produced.

4. The method of producing the intermediate film for laminated glass according to claim 3
wherein dissimilar pressures are applied to axial ends of said first and second cooling pressure rolls to cause deflection of the rolls and thereby reduce the respective clearances in the manner of a curve in the axial direction.

5. A laminated glass comprising the intermediate film for laminated glass according to claim 1 or 2.

6. A roll of intermediate film for laminated glass
increasing in thickness of the film from one edge to the other edge in the axial direction,
which comprises windings of two continuous strips of an intermediate film as wound in superimposition one on the other with its edge of one strip thinner in thickness being aligned with its edge of the other strip greater in thickness.

7. A method of producing a roll of intermediate film for laminated glass
increasing in thickness of the film from one edge to the other edge in the axial direction,
which comprises winding two continuous strips of an intermediate film as rolled up in superimposition one on the other with its edge of one strip thinner in thickness being aligned with its edge of the other strip greater in thickness.
